(19) United States
(12) Patent Application Publication
(10) Pub. No.: US 2026/0143344 A1
(43) Pub. Date: May 21, 2026

(54) VERIFIED TRANSMISSION AND STORAGE OF FIELD DATA

(71) Applicant: Sensia Netherlands B.V., Rotterdam (NL)

(72) Inventors: Hugh Donohoe, Inverurie (GB); Thomas Madden, Duncan, OK (US); Jeffery P. Anderson, Beaumont (CA); Srikanth G. Mashetty, Houston, TX (US); Norman Andrew Weatherhead, Kitchener (CA)

(73) Assignee: Sensia Netherlands B.V., Rotterdam (NL)

(21) Appl. No.: 19/393,560

(22) Filed: Nov. 18, 2025

Related U.S. Application Data
(60) Provisional application No. 63/722,278, filed on Nov. 19, 2024.

(51) Int. Cl. H04W 12/106; H04W 12/61

(52) U.S. Cl. CPC H04W 12/106; H04W 12/61

(57) ABSTRACT

One implementation of the present disclosure is a system including a cloud computing system. The cloud computing system is configured to receive a request from an application indicating a piece of field equipment and a period of time. The cloud computing system is also configured to retrieve appended field data from a memory storage, wherein the appended field data comprises field data, a second checksum, and a second timestamp. The cloud computing system is also configured to identify the second timestamp and the second checksum of the appended field data. The cloud computing system is also configured to receive a first timestamp and a first checksum from the edge device. The cloud computing system is also configured to provide the field data to the application, responsive to a determination that the first checksum matches the second checksum and the first timestamp matches the second timestamp.

### CROSS REFERENCE

This application claims the benefit of and priority to Provisional Application US Application 63/722278, filed Nov. 19, 2024, incorporated herein by reference in its entirety.

### BACKGROUND

The present disclosure relates generally to secure transmission of data. More specifically, the present disclosure relates to systems and methods to verify and transmit logged data for devices in industrial systems, such as gas and oil extraction stations.

### SUMMARY

One implementation of the present disclosure is a system. The system includes field equipment configured to collect field data associated with operation of the piece of field equipment. The system also includes an edge device communicatively coupled to the field equipment and configured to append a first checksum and a first timestamp to the field data. The system also includes a cloud computing system communicatively coupled to the edge device. The cloud computing system includes a processor configured to receive a request from an application indicating the field equipment and a period of time. The processor is also configured to retrieve appended field data from a memory storage of the cloud computing system, wherein the appended field data comprises the field data, a second checksum, and a second timestamp.

The processor is also configured to identify the second timestamp and the second checksum of the appended field data. The processor is also configured to receive the first timestamp and the first checksum from the edge device. The processor is also configured to provide the field data to the application, responsive to a determination that the first checksum matches the second checksum and the first timestamp matches the second timestamp.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a converged controller communicating with field equipment, input devices, and output devices, according to some embodiments.

FIG. 4 is a block diagram of a system to verify and transmit field data, according to some embodiments.

FIG. 5 is a block diagram of a control system for an edge device, which can be implemented by the system of FIG. 4, according to some embodiments.

FIG. 6 is a block diagram of a method for transmitting field data to an application, according to some embodiments.

FIG. 7 is a block diagram of a display of a user interface device, according to some embodiments.

FIG. 8 is a flow diagram of a method for transmitting and logging encrypted field data from an edge device to a cloud computing system, according to some embodiments.

FIG. 9 is a flow diagram of a method for transmitting encrypted field data from a cloud computing system to an edge device, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, one embodiment of the present disclosure refers to a system for transmission and storing of field data. Field data is collected by field equipment, the field data relating to operation of the field equipment. The field data is transmitted to an edge device. The edge device is configured to append a timestamp and a checksum to the field data, and encrypt the field data such that the content of the field data can not be accessed without a decryption key. In some embodiments, the edge device is configured to store the timestamp and the checksum in memory. The edge device is configured to transmit the encrypted field data to a cloud computing system. The cloud computing system is configured to store the encrypted field data in an indexable log file. The log file includes historic field data associated with operation of the field equipment over relatively long intervals. In some embodiments, a user interface communicatively coupled to the cloud computing system and be configured to generate reports (e.g., audits) of the field data responsive to user requests.

One embodiment of the present disclosure relates to a method for storing field data by the edge device. The edge device is configured to receive the field data from the field equipment. The edge device may append the timestamp and the checksum, and encrypt the appended field data such that the content of the field data can not be accessed without the decryption key. The edge device is configured to transmit the encrypted field data to the cloud computing system for storage at the cloud computing system. The edge device is configured to store the timestamp and checksum in memory. Storing the timestamp and checksum may enable the cloud computing system to verify that the field data was not manipulated or otherwise tampered with during storage. Verification of the field data includes a comparison of the timestamp and checksum stored by the edge device to the timestamp and checksum stored by the cloud computing system (in the log file).

One embodiment of the present disclosure relates to transmitting encrypted field data to the edge device from the cloud computing system. The transmission may be responsive to a request from a user, or a trusted application of the system. The cloud computing system is configured to receive a request form the edge device for field data. The request can identify a piece of field equipment, a type of field data, and/or a desired time period. The cloud computing system is configured index the log file to retrieve the encrypted field data stored in the log file. The cloud computing system is configured to identify, from the log file, a first timestamp and a first checksum of the encrypted field data. The cloud computing system is configured to retrieve, from storage of the edge device, a second timestamp and a second checksum of the field data. In some embodiments, the cloud computing system compares the first timestamp and the second timestamp to ensure that the cloud computing system is preparing to transmit the proper data. The cloud computing system may compare the first checksum to the second checksum to ensure that the encrypted field data was not manipulated or otherwise changed while stored in the logfile. The cloud computing system is configured to transmit, responsive to a determinations that the timestamps and the checksums match, the encrypted field data to the edge device.

### Hydrocarbon Site Overview

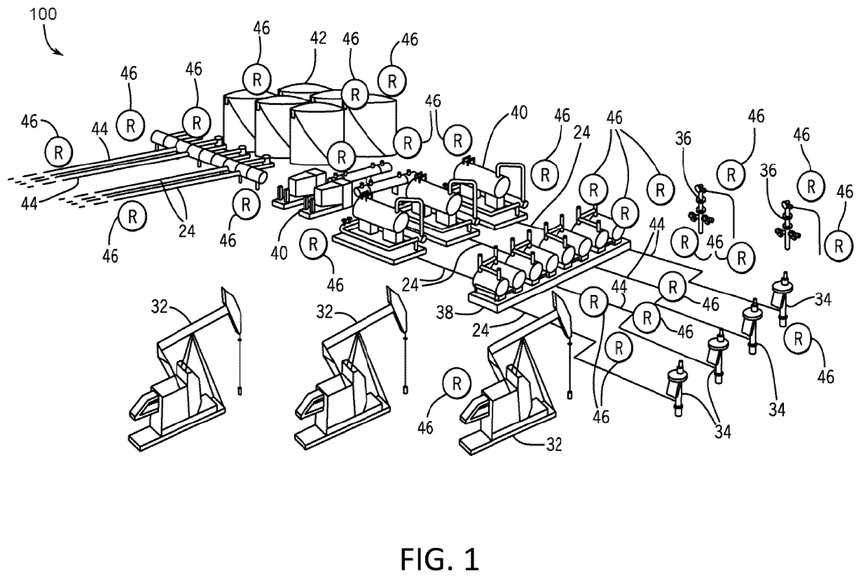

Referring now to FIG. 1, a hydrocarbon site 100 can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

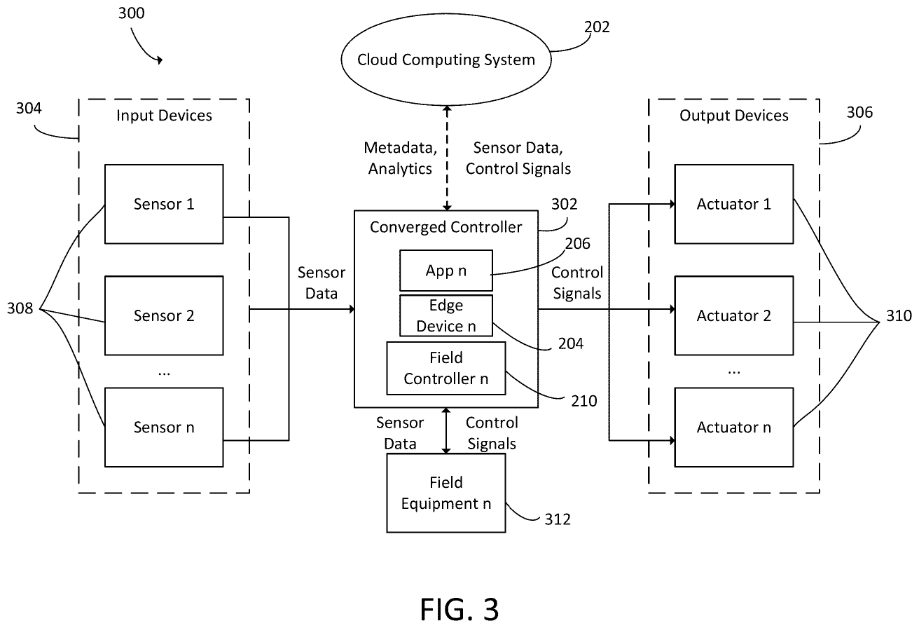

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more converged controllers 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the wellhead 30, key performance indicators (KPIs) associated with the wellhead 30, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

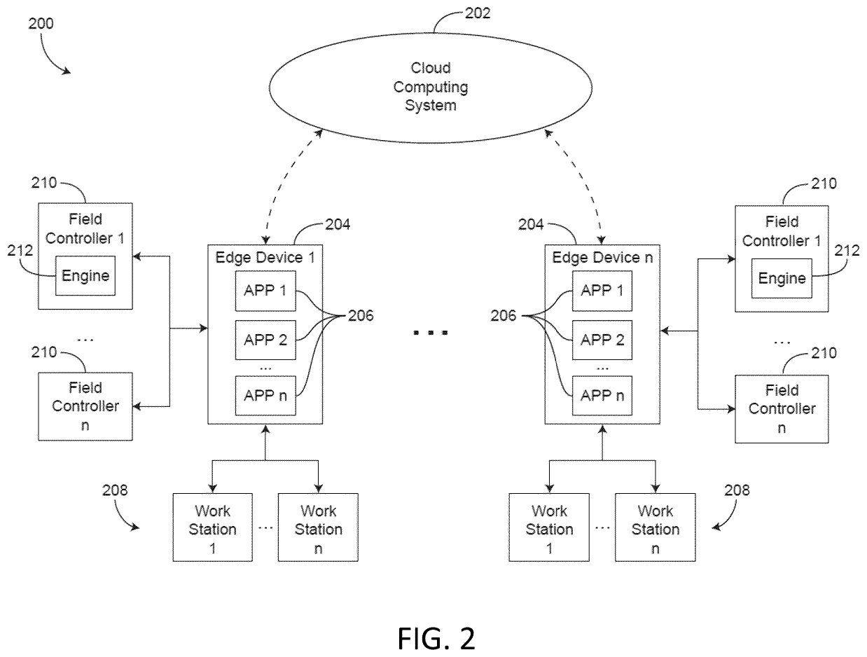

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuity, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

Edge devices 204 may be configured to run, perform, implement, store, etc., one or more applications 206 thereof. Application (n) 206 indicates any number of the application 206 can be run on the edge devices 204. Additionally, some or all processing circuity, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., system 200).

Field controllers 210 may be configured to control various operations at a well site and are communicably coupled with edge devices 204. In some embodiments, field controllers 210 are configured to operate (e.g., provide control signals to, provide setpoints to, adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single work station 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Converged Controller

Referring now to FIG. 3, control system 300 for performing control of output devices 306 based on input devices 304 is shown, according to exemplary embodiments. Control system 300 is shown to include a converged controller 302 including edge device 204, application 206, cloud computing system 202, field controller 210, field equipment 312, input devices 304, and output devices 306. Field equipment (n) 312 indicates that any number of the field equipment 312 can be included in the control system 300.

The converged controller 302 can be a device configured to function as and include the edge device 204 and the field controller 210. In some embodiments, the converged controller 302 includes all the functionality of the edge device 204 and the field controller 210. For example, the converged controller 302 can both control equipment and optimize performance of the equipment. The converged controller 302 can be, for example, a HCC2 controller manufactured by Sensia LLC in some embodiments. The HCC2 controller can include analog acquisition hardware and software. In some embodiments, the converged controller 302 includes wired or wireless communication interfaces (e.g., jacks, antennas, transmitters, receivers, transceivers, transmitters, wire terminals, etc.) for conducting data communications with various edge devices, RTUs, converged controllers, and/or cloud computing system 202. For example, the converged controller 302 can include a Wi-Fi transceiver, cellular, or mobile phone communication transceivers for communication via wireless communication network.

Input devices 304 may be configured to provide various sensor data and/or field measurements from hydrocarbon site 100 to the converged controller 302 for processing. For example, sensor 308 of input devices 304 is measuring the pump speed of pump 34. Sensor 308 provides the pump speed of pump 34 to converged controller 302 at regular intervals (e.g., continuously, ever minute, every 5 minutes, etc.). Input devices 304 may be connected wired or wirelessly to converged controller 302 or any other device within system 300. In some embodiments, input devices 304 are coupled to various site equipment (e.g., pumps, pump jacks, cranes, etc.) and provide operational data of their respective site equipment to converged controller 302.

In some embodiments, sensor(s) 308 refer to physical sensors (e.g., temperature sensors, flow sensors, etc.) and/or virtual sensors (e.g., inferential sensors, soft sensors, etc.). In some embodiments, virtual sensors provide identical or similar information as would a physical sensor, only via software applications. In some embodiments, virtual sensors learn to interpret the relationships between the different variables and observe readings from various instruments. For example, rather than implementing several physical sensors at a site (e.g., hydrocarbon site 100), one or more virtual sensors may be placed on a simulation model to achieve identical or similar results.

Output devices 306 may be configured to receive control signals from converged controller 302 and adjust operation based on the received control signals. For example, converged controller 302 determines that pump 34 is operating at a lower pump speed than is considered optimal. The converged controller 302 subsequently sends a control signal to actuator 310 to increase pump speed for pump 34. In some embodiments, output devices 306 are configured to act as any device (e.g., actuator, etc.) capable of adjusting operation of site equipment within hydrocarbon site 100. In some embodiments, various other field equipment (e.g., field equipment 312) include some or all of the functionality of input devices 304 and output devices 306 and provide sensor data and receive control signals from converged controller 302. As seen in FIG. 3, sensor (n) 308 and actuator (n) 310 indicates that any number of the sensor 308 and the actuator 310 can be included and used by the control system 300.

In some embodiments, control system 300 is configured to analyze various sets of data (e.g., metadata) to determine control schema that is optimal for hydrocarbon site 100. A significant amount of processing for this may be performed by converged controllers (e.g., converged controller 302), instead of processing all metadata analytics in the cloud, as processing the data in on-site or proximate edge devices can decrease latency compared to sending the data to cloud computing system 202 for processing. For example, sensors 308 provide metadata to converged controller 302. Converged controller 302 processes the data to determine the type of data and/or domain from which the data is received and analyzes the data. An application within converged controller 302 e.g., application 206) may analyze the metadata to make decisions about the control schema that would have been otherwise unnoticed by processing within control system 300. For example, application 206 may infer that the data received has been received by a flow meter sensor (e.g., sensor (1) 308), based on the patterns seen in the data and a prior data that converged controller 302 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 308 and sensor (2) 308 may be flow sensors, but from different vendors. As such, sensor (1) 308 may provide data to field controller 210 in a different format than sensor (2) 308. However, application 206 of the converged controller 302 may still be able to standardize the data and determine that both sets of data are from flow sensors, despite the received data being in different formats (e.g., one data set is provided under resource description framework (RDF) specifications, one data set is provided as data objects, etc.). In various embodiments, allowing converged controller 302 to perform some or all of the metadata analytics allows for improved data analytics and control schema without significantly increasing processing latency.

### Verified Transmission and Logging of Field Data

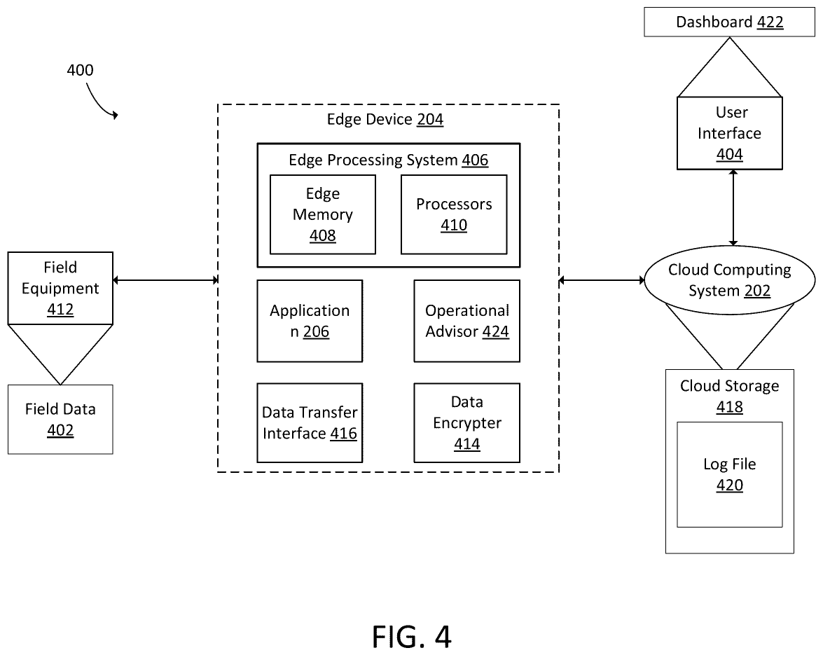

Referring now to FIG. 4, depicted is a system 400 for verifying and transmitting field data, according to exemplary embodiments. System 400 is shown to include the edge device 204. Edge device 204 is shown to include an edge processing system 406, one or more applications 206, an operational advisor 424, a data transfer interface 416, and a data encryptor 414. System 400 is shown to include field equipment 412. System 400 is shown to include a cloud computing system 200. The cloud computing system 200 includes cloud storage 418. Cloud storage 418 includes a log file 420. System 400 is shown to include a user interface 404.

Field equipment 412 can include the pumpjack 32, the submersible pumps 34, well trees 36, and/or other devices for assisting the monitoring and flow of liquids or gasses, such as petroleum, natural gasses and other substances. In some embodiments, the field data 402 includes characteristics of the field equipment 412. Field equipment 412 can include one or more sensors or other data collection devices configured to collect field data 402 of or relating to the field equipment 412. For example, the sensors can measure pressure, temperature, fill level, flow rates, power consumption, and other metrics associated with the field equipment 412.

As shown, the field equipment 412 can transmit the field data 402 to the edge device 204, and/or receive instructions from the edge device 204 to adjust settings of the field equipment 412. The transmissions/receptions can be via wireless communication (e.g., Bluetooth, Wi-Fi, cellular communication, etc.) or wired connection (e.g., ethernet, fiber optic, etc.). In some embodiments, the settings of the field equipment 412 relate to operations of the field equipment 412, such as pumping rates or other capabilities of the field equipment 412. In some embodiments, settings of the field equipment 412 relate to operations of the sensors, such as calibration settings or field data 402 collection settings.

Edge device 204 serves as a communication device between the field equipment 312 and the cloud computing system 202. The edge device 204 includes the edge processing system 406 configured to control the edge device 204. The edge processing system 406 includes edge memory 408 configured to store computer readable instructions to be executed by processors 410. The edge memory 408 includes instructions for controlling the various components of the edge device 204. In some embodiments, edge memory 408 is configured to store the field data 402 transmitted by the field equipment, and delete the field data 402 after a predetermined time period.

Edge device 204 is shown as including operational advisor 424 configured to select a desired operation of the edge device. In some embodiments, the desired operations include requesting field data 402 from the field equipment 412. In some embodiments, the desired operations include encrypting field data from the field equipment 412 and/or from the edge memory 408. In some embodiments, the desired operations include transmitting or otherwise sending field data 402 (e.g., encrypted or otherwise) to an application n 206 (referred to from hereon as application 206). In some embodiments, the desired operations include other operations of the edge device 204, and edge device 204 interactions with the cloud computing system 202 and/or the field equipment 412.

Edge device 204 includes one or more data transfer interfaces, shown as data transfer interface 416. In some embodiments, data transfer interface 416 is a physical port configured to accept or otherwise receive an external storage device. For example, data transfer interface 416 is a USB port configured to download/upload the field data 402 from/to the external storage device. In some embodiments, the data transfer interface 416 is a device configured to transmit/receive field data 402 wirelessly from the field equipment 412. For example, the data transfer interface 416 is a wireless transceiver configured to transmit/receive the field data 402.

Edge device 204 includes a data encryption mechanism, shown as data encryptor 414. The data encryptor 414 is configured to encrypt field data 402 that is received from the field equipment 412. The data encryptor 414 may encrypt the field data 402 such that in the event of a security breach, the field data 402 can not be determined without an encryption key. The data encryptor 414 may be configured to generate one or more encryption keys such that a trusted application or device can decrypt the encrypted field data 402. The data encryptor 414 is configured to append information to the field data 402, such as a timestamp and/or a checksum. The information can be appended to the field data 402 before or after the field data 402 is encrypted.

The application 206 is configured to process the field data to adjust operations of the field equipment 412. The application 206 may be an application of the edge device and/or an application of a trusted external device. The application 206 can receive encrypted field data 402 from the edge device 204. Upon receiving the encrypted field data 402, the application 206 can decrypt the field data 402 using a decryption key stored at the application 206. In some embodiments, the application 206 processes the field data to determine the current operations (e.g., performance, KPIs, output) of the field equipment 412, and if an adjustment is necessary. The application 206 can then transmit an instruction to the field equipment (e.g., directly, via the edge device 204) to adjust operations of the field equipment 412.

The edge device 204 is configured to transmit or otherwise send the field data 402 (encrypted or otherwise) to the cloud computing system 202. The cloud computing system 202 includes any processing circuitry, processors, memory, etc., or combination thereof that are positioned remotely from hydrocarbon site 100. The cloud computing system includes cloud storage 418, configured to remotely store historic (e.g., past, former) field data 402 of the field equipment 412. The cloud storage 418 includes a log file 420 configured to organize the historic field data 402. For example, the log file may store the field data 402 based on timestamp and/or other features of the field data 402.

In some embodiments, the cloud computing system 202 is communicatively coupled to the user interface 404. The user interface 404 is shown as displaying a dashboard 422 including the field data 402. The dashboard 422 may include an organized report (e.g., generated by the cloud computing system 202) of the field data 402 based on a user input into the user interface 404 requesting the report. The dashboard 422 is shown as including selectable elements configured to parse the report or otherwise allow the user to interact with the report. The user interface 404 may include selectable elements configured to allow the user to input commands to be executed by the field equipment 412. For example, the user can input a command into the user interface 404 to increase the pump rate of the field equipment 412.

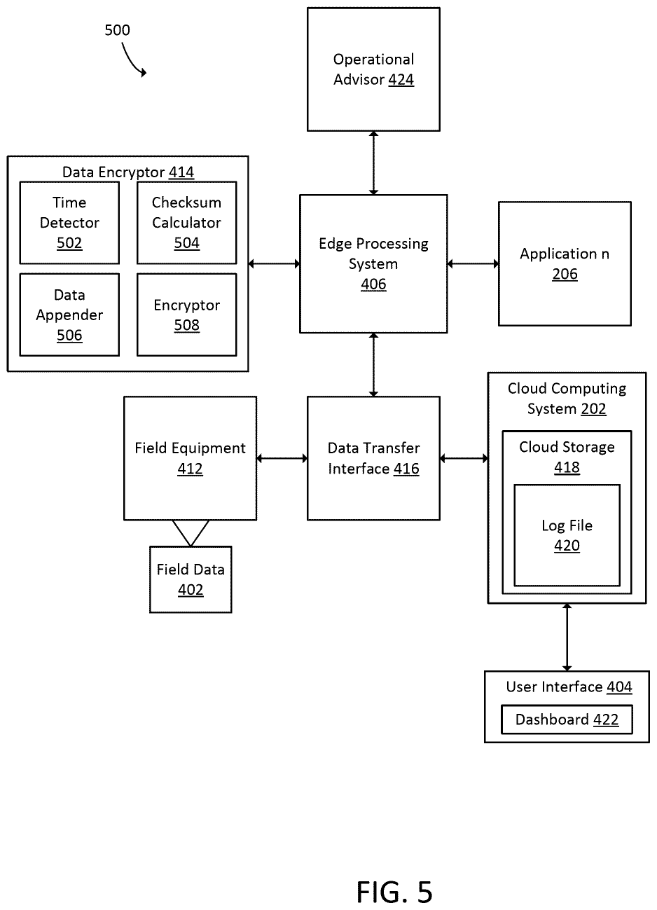

Referring to FIG. 5, depicted is a communication system 500 for transmitting field data, according to an exemplary embodiment. In some embodiments, system 500 is configured to transmit field data for data storage purposes. In alternate embodiments, system 500 is configured is to transmit field data for purposes involving adjusting operations of field equipment. Various embodiments of system 500 include other components and communications not depicted in FIG. 5.

The field equipment 412 can be configured to retrieve or otherwise collect field data 402 associated with the performance of the field equipment 412. The field equipment 412 can be configured to transmit the field data 402 to the data transfer interface 416. In some embodiments, the field data 402 is transmitted wirelessly to a transceiver of the data transfer interface 416. In alternate embodiments, the field data 402 is uploaded to an external storage device (e.g., flash drive, hard drive, other memory device) and downloaded via a communication port of the data transfer interface 416.

Upon receipt of the field data 402 by the data transfer interface, the field data 402 is transmitted to the edge processing system 406. In some embodiments, the edge processing system 406 stores the field data 402 in memory (e.g., storage) of the edge processing system 406. The data encryptor 414, upon receipt of the field data 402, can append identifying data (e.g., information, characteristics, etc.) to the field data 402. A time detector 502 of the data encryptor 414 is configured to determine the time that the field data 402 was collected by the field equipment 412 and/or the time that the field data 402 was transmitted to the data encryptor 414. The time detector 502 generates a timestamp including the time. The timestamp may include information associated with the time and/or the date that the field data 402 was collected.

A checksum calculator 504 of the data encryptor 414 is configured to generate a checksum associated with the field data 402. The checksum can be a piece of information used to verify the integrity of the data. In some embodiments, the checksum is based on the content of the data, such the sum of the field data 402 bytes, modulo a predetermined number. As a non-limiting example, the checksum calculator 504 sums the bytes of the field data 402, divide by a predetermined number, and determine the remainder. The checksum calculator 504 may determine the checksum through other methods as well, such as cryptographic hash functions or other logic functions.

The data appender 506 of the data encryptor 414 appends the timestamp and/or checksum to the field data 402. The checksum and/or timestamp can be appended to the front of the field data 402, the end of the field data 402, or a different place within the field data that can be identified by a device that uses the encrypted field data 402. Once the checksum and/or timestamp are appended to the field data 402, the encryptor 508 encrypts the appended field data 402. The encryptor 508 may be configured to encrypt the field data 402 such that the content of the field data 402 can not be accessed without applying a decryption key. In some embodiments, the decryption key is predetermined or generated by the encryptor 508. The decryption key can be stored by the data encryptor 414 and/or a different device.

Once the field data 402 is encrypted by the data encryptor 414, the encrypted field data 402 can be transmitted to the edge processing system 406. The edge processing system 406 is configured to store the encrypted field data 402 to its short-term memory storage. In some embodiments where the unencrypted field data 402 was stored in short term memory of the edge processing system, the encrypted field data 402 can replace the unencrypted field data 402.

In some embodiments, the edge processing system 406 is configured to delete the field data 402 after a predetermined amount of time. For example, the memory of the edge processing system 406 is configured to be short term memory (e.g., not store data for more than a certain number of days), such that edge memory does not fill up and cause delays by the edge processing system 406.

In some embodiments, the operational advisor 424 can instruct the edge processing system 406 to transmit the encrypted field data 402 to the application 206. The application 206 is configured to process the encrypted field data 402 to determine the current functionality (e.g., operability, efficiency, performance) of the field equipment 412. The application 206 may be configured to decrypt the encrypted field data 402 using a decryption key stored on the application 206. In some embodiments, the application 206 determines if an adjustment of the field equipment is necessary based on the field data 402. For example, the application 206 determines that the pump rate of the field equipment 412 should be increased.

In some embodiments, the operational advisor 424 instructs the edge processing system to transmit the encrypted field data 402 from the data transfer interface 416 to the cloud computing system 202 for storage. In some embodiments, the data transfer interface wirelessly transmits the encrypted field data 402. The cloud computing system 202 can be a computing system (e.g. processors coupled with memory) of a remote device (e.g., a device not in the vicinity of the field equipment 412). Upon receipt of the encrypted field data 402, the cloud computing system 202 may store the encrypted field data 402 to cloud storage 418, which is configured to store historic (e.g., past, former) field data 402 of the field equipment 412. The cloud storage 418 includes a log file 420 configured to organize the historic field data 402. For example, the log file stores the field data 402 based on timestamp and/or other features of the field data 402.

User interface 404 can be configured to display the field data 402 that is stored in the log file 420. The user interface 404 can be configured to transmit a request to the cloud computing system 202 for the field data 402. Upon receiving the request, the cloud computing system 202 is configured to parse the log file for the desired field data 402. The cloud computing system 202 can decrypt the field data 402 prior to transmitting the requested field data 402 to the user interface. In some embodiments, the user interface 404 includes a dashboard 422 configured to display the field data in an organized fashion. The dashboard 422 includes an organized report (e.g., audit), generated by the cloud computing system 202, of the field data 402 based on a user input into the user interface 404 requesting the report. The dashboard 422 includes selectable elements configured to parse the report or otherwise allow the user to interact with the report. The user interface 404 includes selectable elements configured to allow the user to input commands to be executed by the field equipment 412. For example, the user can input a command into the user interface 404 to increase the pump rate of the field equipment 412.

The user interface 404 is configured to transmit an instruction to the cloud computing system 202 to transmit encoded field data 402 to the data transfer interface 416, to be used by the application 206. In alternate embodiments, the application 206 is configured to transmit a request to the cloud computing system 202 to transmit encrypted field data 402. Upon receipt of the request (e.g., request from the user interface 404, request from the application 206), the cloud computing system 202 may parse the log file for the requested field data 402.

In some embodiments, the cloud computing system 202 is configured to check or otherwise validate the field data 402 for signs of tampering (e.g., change, manipulation, adjustment). The cloud computing system 202 can identify the checksum of the field data 402 to determine whether the checksum matches (e.g., is proper in relation to) the field data 402. In the event that the checksum does not match the field data 402, the cloud computing system 202 may block or otherwise disable the transmission of field data 402, and send an alert to the user interface indicating that the field data 402 is compromised. If the checksum does match the field data 402, the cloud computing system 202 may proceed with transmitting the field data 402.

Various embodiments of system 500 include additional or alternate safety measures to minimize the risk of having data stolen and/or fraudulently manipulated. In some embodiments, application 206 (or a different application) is a honeypot (e.g., decoy, fake, distraction) application, configured to be easily accessible by an external device (e.g., hacker, thief, etc.). The application 206 may be configured to collet information associated with the external device (e.g., IP address, location information, user information) and transmit an alert to the user interface 404 indicating that the external device has accessed the application 206. The application 206 includes decoy (e.g., fake) data that is unassociated with the system 500, such that when stolen/manipulated, no data of the system is stolen/manipulated.

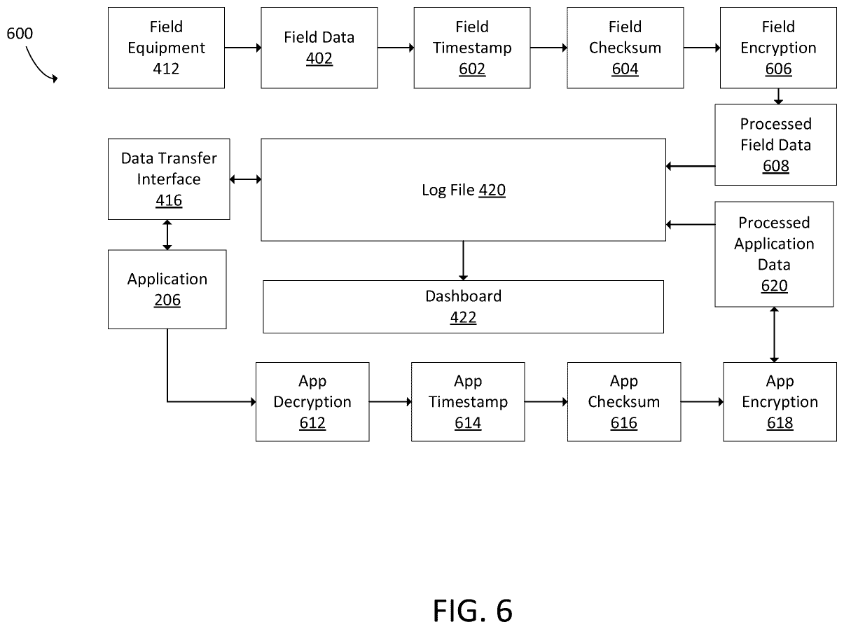

Referring to FIG. 6, depicted is a workflow (process, data flow, etc.) 600 for storing and accessing field data, according to an exemplary embodiment. Workflow 600 can be executed with any/all components of system 400 and system 500 or be executed with different components. Initially, field data 402 is collected from a piece of field equipment 412. The field data includes information relating to operations of the field equipment 412, such as flow rate, pump rate, temperature, pressure, and/or other metrics. Next, the field data 402 is appended with a field timestamp 602. The field timestamp indicates a time that the field data 402 was collected, or a time that the field data 402 was processed. The field data 402 may then be appended with a field checksum 604. The field checksum 604 can be used to validate the field data. For example, the field checksum 604 initially matches an unaltered version of the field data 402, but if the field data 402 is manipulated, the field checksum 604 may no longer match the field data 402.

After appending the field timestamp 602 and the field checksum 604, the appended field data 402 can be encrypted using field encryption 606. In some embodiments, the field encryption 606 is executed such that the content of the field data 402 can not be accessed without applying a decryption key. Once the field data 402 is encrypted, the processed field data 608 (e.g., the encrypted field data, including appended field timestamp 602 and field checksum 604) is stored in a log file 420. Once the processed field data 608 is stored in the log file 420, the field timestamp 602 and the field checksum 604 can be stored in an edge device (e.g., edge device 204) for future reference. The log file 420 is configured to store the processed field data 608 in a way that can be parsed (e.g., searched, browsed) for specific processed field data 608. For example, the log file is searchable based on the field timestamp 602.

In some embodiments, processed field data 608 is transmitted to the application 206 from the log file 420. The data transfer interface 416 can facilitate the transmission of processed field data 608 from the log file 420 to the application 206. In some embodiments, the processed field data 608 is transmitted from the log file 420 to the application 206 responsive to a request from the application for the processed field data 608. In alternate embodiments, the transmission is based on a request from a different device (e.g., user interface, field device, etc.). Before transmitting the processed field data 608, the processed field data can be checked (e.g., verified) to ensure that the field checksum 604 (stored in the edge device) matches the processed field data 608. Once the determination is made that the field checksum 604 matches the processed field data 608, the processed field data 608 is transmitted to the application 206. Before transmitting the processed field data 608, the processed field data may be checked (e.g., verified) to ensure that the field timestamp 602 matches the timestamp of the processed field data 608.

Upon receiving the processed field data 608, the application 206 is configured to decrypt the processed field data 608, shown as app decryption 612. The application 206 can store or otherwise have access to the decryption key configured to decrypt the processed field data 608 into field data 402. The application 206 can use the field data 402 to adjust operation of the field equipment 412.

In some embodiments, the application 206 can manipulate or otherwise convert the field data 402 into app data for an intended use. If the application manipulates (e.g., alters, adjusts, converts, etc.) the field data 402, the application 206 (or another device) can append a timestamp to the app data, shown as app timestamp 614. The app timestamp 614 can be configured to indicate a time that the app data was manipulated by the application 206. The app data is shown to be appended with an app checksum 616. The app checksum 616 can be used to validate the app data. For example, the app checksum 616 matches the manipulated version of the app data, but if the app data is further manipulated, the app checksum 616 no longer matches the app data.

After appending the app timestamp 614 and the app checksum 616, the appended app data is shown to be encrypted using app encryption 618. The app encryption 618 can be executed such that the content of the app data can not be accessed without applying a decryption key. Once the app data is encrypted, the processed application data 620 (e.g., the encrypted app data, including appended field timestamp 602 and field checksum 604) is stored in the log file 420.

In alternate embodiments, the application 206 does not manipulate or otherwise convert the field data 402. In these cases, it may be useful to ensure that the data was not manipulated by the application 206. The app checksum 616 can be compared to the field checksum 604 to determine whether the app checksum 616 matches the field checksum 604. In some embodiments, if the field checksum 604 and the app checksum 616 do not match, a message may be displayed to a user device indicating that the data of the log file 420 is compromised. The processed application data 620 can be compared to the processed field data 608 to determine if the processed application data 620 was altered in any way.

At any time, the data stored in the log file 420 (e.g., processed field data 608, processed application data 620) can be converted for display to the dashboard 422. In some embodiments, the dashboard 422 includes an organized report (e.g., audit), generated by the cloud computing system 202, of the field data 402 based on a user input into the user interface 404 requesting the report. The report can be based on user-selected criteria of the field equipment 412 (e.g., pump rate measurements over a specific period of time). The dashboard 422 includes selectable elements configured to parse the report or otherwise allow the user to interact with the report. The user interface 404 includes selectable elements configured to allow the user to input commands to be executed by the field equipment 412. For example, the user can input a command into the user interface 404 to increase the pump rate of the field equipment 412. In some embodiments, the dashboard 422 displays system alerts (e.g., processed field data 608 timestamp/checksum does not match field timestamp 602/field checksum 604).

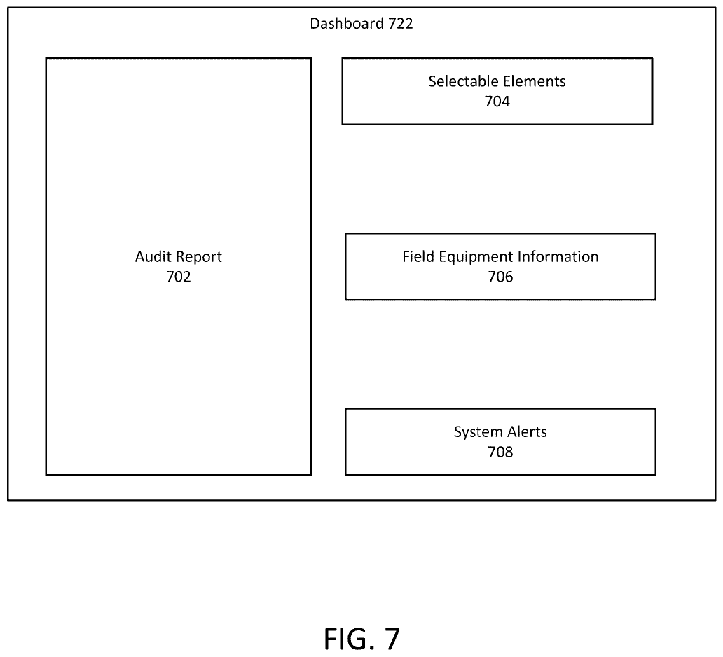

Referring to FIG. 7, depicted is the contents of a dashboard 722, according to an exemplary embodiment. The dashboard 722 includes any characteristics of the dashboard 422, such as the selectable elements and/or the report (e.g., audit). The dashboard 722 includes an audit report 702, configured to display information related to operation of field equipment. Generation of the audit report 702 is responsive to interaction with one or more selectable elements 704. The selectable elements 704 are configured to receive user inputs, such as desired criteria and a time period for the report, as well as a desired piece of field equipment. For example, the user can specify a flow rate report for a two-month time period for a specific piece of field equipment. The selectable elements 704 can be buttons, text boxes, drop down lists, or other user-selectable icons.

In some embodiments, the audit report 702 includes one or more selectable elements 704 configured to allow the user to interact with the audit report 702. The selectable elements 704 can include a scroll bar. The scroll bar may be configured to allow the user to move up and down to different parts of the audit report 702, so that the user can view audit reports 702 that are longer than (e.g., unable to fit on) the dashboard 722. The selectable elements 704 can include a search bar. The search bar is configured to allow the user to search for elements within the audit report 702. For example, the user can search for a specific time within the time range of the audit report 702.

In some embodiments, the dashboard 722 is configured to display field equipment information 706. The field equipment information 706 relates to the current operations of field equipment associated with the dashboard. The field equipment information 706 includes information about the operability of field equipment, the current state (e.g., on or off, active or disabled) of the field equipment, or other alerts associated with the field equipment 312.

In some embodiments, the dashboard 722 displays system alerts 708. The system alerts 708 can be related to the security of the system, such as alerts indicating that a first checksum and a second checksum do not match, alerts indicating that a first timestamp does not match a second timestamp, and/or that an external device (e.g., hacker) has accessed a honeypot application. The system alerts 708 may require user acknowledgement of the alert to remove the alert from display on the dashboard 722. For example, the user interacts with a selectable element 704 to acknowledge the alert and remove it from display.

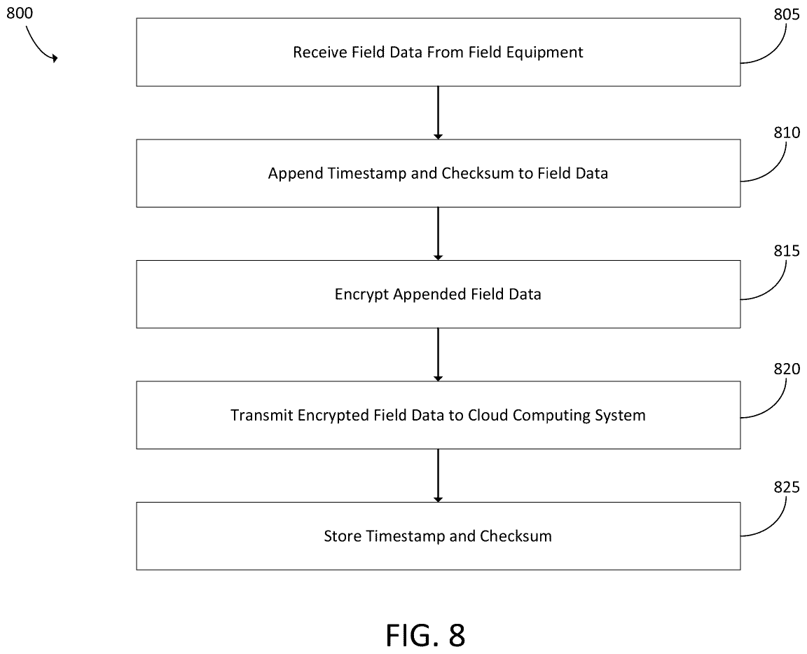

Referring to FIG. 8, depicted is a flow diagram for a method 800 of receiving, encrypting, and storing field data associated with field equipment by an edge device (e.g., edge device 204). At step 805, field data (e.g., field data 402) is received from field equipment (e.g., field equipment 412). The field data can be associated with operation of the field equipment, such as temperature, pressure, flow rate, pump rate, or other metrics. At step 810, a timestamp (e.g., field timestamp 602) is appended to the field data. The timestamp can be associated with a time that the field data was collected, or a time that the field data is collected by the edge device. A checksum (e.g., field checksum 604) is appended to the field data. The checksum can be used to verify that the data has not been manipulated while being stored.

At step 815, the appended field data is encrypted by the edge device. The field data can be encrypted such that the contents of the field data can not be accessed or otherwise understood without decryption of the field data. Decryption of the field data may only be performed by a trusted application, the cloud computing system, or the edge device that stores a decryption key associated with the encryption.

At step 820, the encrypted field data is transmitted to a cloud computing system (e.g., cloud computing system 202). In some embodiments, the cloud computing system is a remote device/server communicatively coupled to the edge device and capable of transmitting/receiving information to/from the edge device. The encrypted field data can be stored or otherwise maintained at the cloud computing system. At step 825, the timestamp and checksum of the field data is stored at the edge device without, for example, requiring storage of the field data at the edge device. Storing the timestamp and checksum can facilitate comparisons of the timestamp and checksum of the cloud computing system when stored information is requested from the cloud computing system. Storing the timestamp and checksum without storing the field data at the edge device (e.g., while deleting the field data from the edge device) can preserve memory space at the edge device and ensure that the storage of the edge device is not overloaded and/or increase the amount of time for which a record of data collection and transmission (i.e., the timestamp and checksum) is stored as compared to a technique of storing all field data indefinitely.

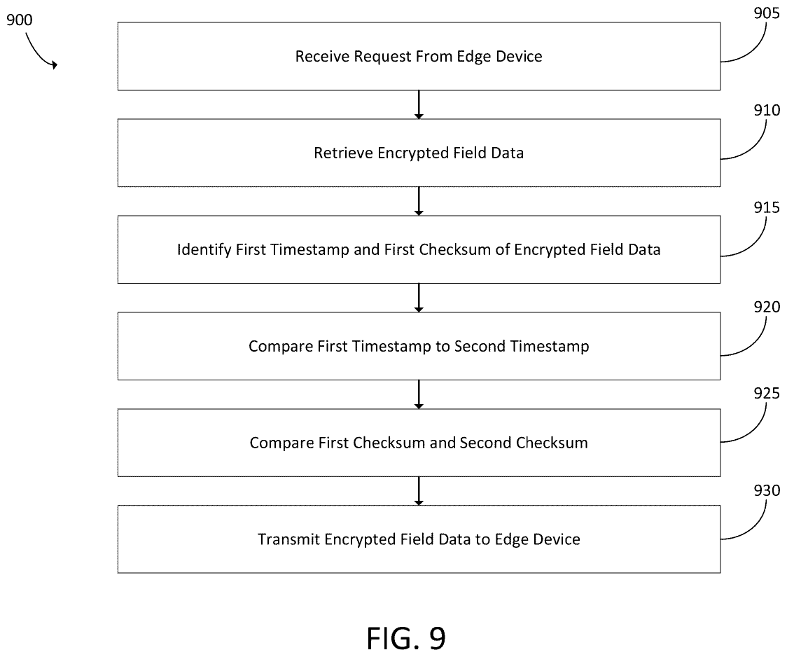

Referring to FIG. 9, depicted is a method 900 for secure transmission of field data. At step 905, a request, sent by an edge device (e.g., edge device 204), to a cloud computing system (e.g., cloud computing system 202) is received. The request can be a request for field data (e.g., field data 402), and include information relating to a piece of field equipment (e.g., field equipment 412), a desired type of field data, and/or a desired time period. At step 910, encrypted field data is retrieved by the cloud computing system. The cloud computing system is configured to index a log file (e.g., log file 420) stored on the cloud computing system to find the correct field data associated with the request.

At step 915, a first timestamp and a first checksum of the encrypted field data are identified by the cloud computing system. The first timestamp and first checksum can be stored appended to the encrypted field data, or separately from the encrypted field data. At step 920, the cloud computing system compares the first timestamp to a second timestamp. In some embodiments, the second timestamp is stored by the edge device. Comparing the timestamps may serve to ensure that the proper field data has been identified. At step 925, the first checksum is compared to a second checksum. The second checksum may be stored by the edge device. In some embodiments, comparing the checksums ensures that the field data was not manipulated or otherwise tampered with while being stored by the cloud computing system.

At step 930, encrypted field data is transmitted to the edge device (from the cloud computing system). If the first timestamp matches the second timestamp, and the first checksum matches the second checksum, the encrypted field data can be transmitted. If the first timestamp does not match the second time stamp, and/or the first checksum does not match the second checksum, an alert can be transmitted for display on a user interface (e.g., user interface 404). The transmission may be delayed until the timestamps and checksums match, or a user acknowledges the alert and approves transmission.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (i.e., permanent or fixed) or moveable (i.e., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A method for securely transmitting field data, comprising:
receiving, by one or more processors of an edge device, field data of a piece of field equipment;
creating a log file by appending, by the one or more processors, identifying information to the field data, wherein the identifying information comprises a timestamp and a checksum;
encrypting, by the one or more processors, the log file;
transferring, by the one or more processors, the log file to an external device; and
storing, by the one or more processors, the identifying information in a memory storage of the edge device.

2. The method of claim 1, wherein transmitting the encoded field data comprises a wireless communication between the edge device and the cloud computing system.

3. The method of claim 1, wherein the memory storage of the edge device is configured to delete the encoded field data after a predetermined period of time.

4. The method of claim 3, wherein the memory storage of the edge device is a first memory storage, and wherein transferring the log file comprises:
determining that an external storage device is inserted into a data transfer interface of the edge device;
downloading the encoded field data from the first memory storage onto the external storage device.

5. The method of claim 1, wherein the memory storage is a first memory storage, and wherein the cloud computing system comprises a second memory storage comprising a log file, the log file comprising the identifying information and the encoded field data.

6. The method of claim 5, wherein the log file comprises a plurality of identifying information and a plurality of encoded field data for a plurality of field equipment.

7. The method of claim 1, wherein the identifying information comprises an identifier of the piece of field equipment.

8. A method for securely transmitting field data, comprising:
receiving, by one or more processors of a cloud computing system, a request from an edge device, the request indicating a piece of field equipment and period of time;
retrieving, from a first memory storage of the cloud computing system, encoded field data from the piece of field equipment, wherein the encoded field data comprises field data, a first timestamp, and a first checksum;
identifying, by the one or more processors, the first timestamp and the first checksum of the encoded field data;
receiving, by the one or more processors, a second timestamp and a second checksum from the edge device, wherein the second timestamp and the second checksum are stored in a second memory storage of the edge device; and
transmitting, by the one or more processors, the encoded field data to the edge device, responsive to a determination that the first checksum matches the second checksum, and the first timestamp matches the second timestamp.

9. The method of claim 8, wherein the request from the edge device is responsive to an indication by an application of the edge device of the piece of field equipment and the period of time.

10. The method of claim 9, wherein the application is configured to process the encoded field data to adjust an operation of an actuator of the piece of field equipment.

11. The method of claim 8, further comprising:
determining, by the one or more processors, that the first checksum does not match the second checksum; and
transmitting, by the one or more processors, an alert to a user interface indicating that the first checksum does not match the second checksum.

12. The method of claim 8, further comprising:
determining, by the one or more processors, that the first timestamp does not match the second timestamp; and
transmitting, by the one or more processors, an alert to a user interface indicating that the first timestamp does not match the second timestamp.

13. The method of claim 8, wherein the first memory storage of the cloud computing system comprises a log file, the log file comprising the first timestamp, the first checksum, and the encoded field data.

14. A system, comprising:
field equipment configured to collect field data associated with operation of the field equipment;
an edge device communicatively coupled to the field equipment and configured to append a first checksum and a first timestamp to the field data; and
a cloud computing system communicatively coupled to the edge device, comprising a processor configured to:
receive a request from an application indicating the piece of field equipment and a period of time;
retrieve appended field data from a memory storage of the cloud computing system, wherein the appended field data comprises the field data, a second checksum, and a second timestamp;
identify the second timestamp and the second checksum of the appended field data;
receive the first timestamp and the first checksum from the edge device; and
provide the field data to the application, responsive to a determination that the first checksum matches the second checksum and the first timestamp matches the second timestamp.

15. The system of claim 14, further comprising a user interface device communicatively coupled to the cloud computing system and configured to:
transmit a second request to the cloud computing system, the second request indicating the piece of field equipment and the period of time;
receive the field data from the cloud computing system;
receive, from the cloud computing system, an indication whether the first checksum matches the second checksum, and the first timestamp matches the second timestamp;
generate a report comprising the field data, responsive to the indication indicating that the first checksum matches the second checksum, and the first timestamp matches the second timestamp; and
display the report to a display of the user interface device.

16. The system of claim 14, further comprising a user interface device communicatively coupled to the cloud computing system and configured to display an audit of the piece of field equipment performed by the cloud computing system.

17. The system of claim 16, wherein the cloud computing system is programmed to perform the audit by:
transmitting, to the cloud computing system, a criteria for the piece of field equipment, wherein the criteria indicates a type of field data;
receiving, from the cloud computing system, a set of field data associated with the piece of field equipment and the type of field data; and
generating a report comprising the set of field data, wherein the report further comprises compliance information of the set of field data.

18. The system of claim 17, wherein the compliance information includes information associated with a safety function, an emissions function, a cyber security posture, an optimization KPI, or calibration information of the piece of field equipment.

19. The system of claim 14, wherein the application is a first application, and wherein the edge device comprises a second application configured to be easily accessible by an external device, the second application further configured to:
collect information associated with the external device; and
transmit an alert to a client device indicating that the external device has accessed the second application.

20. The system of claim 19, wherein the second application is further configured to resemble the first application, and wherein the second application comprises a decoy of the field data or of other information relating to the field equipment.
